(19) United States
(12) Patent Application Publication
(10) Pub. No.: US 2023/0138847 A1
(43) Pub. Date: May 4, 2023

(54) COMPOSITE FABRIC CONTAINING BIO-BASED FIBERS

(71) Applicant: Milliken & Company, Spartanburg, SC (US)

(72) Inventor: Ramesh Keshavaraj, Inman, SC (US)

(21) Appl. No.: 17/975,941

(22) Filed: Oct. 28, 2022

Related U.S. Application Data
(60) Provisional application No. 63/274,747, filed on Nov. 2, 2021.

(51) Int. Cl. B32B 27/12; D03D 15/283; D06M 17/10; D04B 1/16; D04B 21/16; B32B 7/12; B32B 5/02; B32B 27/36; B32B 27/34; D06M 23/16; B32B 37/12; B32B 38/00; B32B 37/16

(52) U.S. Cl. CPC B32B 27/12; D03D 15/283; D06M 17/10; D04B 1/16; D04B 21/16; B32B 7/12; B32B 5/026; B32B 5/024; B32B 27/36; B32B 27/34; D06M 23/16; B32B 37/12; B32B 38/145; B32B 37/16; D10B 2401/02; D06M 2101/34

(57) ABSTRACT

In a first embodiment, the invention provides a composite fabric which contains a first fabric layer and a thin film. The first fabric layer has an upper and lower side and contains a plurality of synthetic polymer fibers. The synthetic polymer fibers contain at least 15% of bio-based carbon content as measured by ASTM D26866-20 Method B. The thin film is located on the lower side of the first fabric layer and contains at least 15% of biobased carbon content as measured by ASTM D26866-20 Method B. The thin film has an average weight of less than about 30 GSM and has an air permeability of less than about 1 CFM as measured by ASTM D737 @ 125 Pa.

### RELATED APPLICATIONS

This application claims priority to Provisional Patent Application 63/274,747 filed on Nov. 2, 2021, which is herein incorporated by reference.

### TECHNICAL FIELD

This application relates to composite fabric containing a percentage of bio-based fibers.

### BACKGROUND

Outdoor jackets are typically made as two- or three-layer composites where a film is laminated on to an exterior fabric or a film is sandwiched between two layers of fabric in a lamination process. Current products in the market are predominated with either extruded ePTFE films or electro-spun polyurethane membranes. Both these approaches have shown severe drawback both in terms of performance and from sustainability point of view. The e-PTFE film is known to lose its limited breathability overtime because it is not oleophobeically resistant to bodily fluids. Electro spun polyurethanes uses solvents for the spin process and is not environmentally friendly, plus the waterproofness is way inferior compared to e-PTFE membranes. Added factor for the need of a new product is on the cost of producing such membranes. There remains a need for an environmentally friendly, high performance composite for use in garments.

### BRIEF SUMMARY OF THE INVENTION

In a first embodiment, the invention provides a composite fabric which contains a first fabric layer and a thin film. The first fabric layer has an upper and lower side and contains a plurality of synthetic polymer fibers. The synthetic polymer fibers contain at least 15% of bio-based carbon content as measured by ASTM D26866-20 Method B. The thin film is located on the lower side of the first fabric layer and contains at least 15% of biobased carbon content as measured by ASTM D26866-20 Method B. The thin film has an average weight of less than about 30 GSM and has an air permeability of less than about 1 CFM as measured by ASTM D737 @ 125 Pa.

In a second embodiment, the invention provides a composite fabric which contains a first fabric layer and a thin film. The first fabric layer has an upper and lower side and contains a plurality of synthetic polymer fibers. The synthetic polymer fibers contain at least 30% by weight (more preferably at least 40%) of bio-based carbon content as measured by ASTM D26866-20 Method B. The thin film is located on the lower side of the first fabric layer, has an average weight of less than about 30 GSM, and has an air permeability of less than about 1 CFM as measured by ASTM D737 @ 125 Pa.

In a third embodiment, the invention provides a composite fabric made by the process containing the step of forming a first fabric layer having an upper and lower side, where the first fabric layer contains a plurality of synthetic polymer fibers. The synthetic polymer fibers comprise at least 20% of biobased carbon content as measured by ASTM D26866-20 Method B. The method further contains the steps of forming a thin film having an average weight of less than about 30 GSM and has an air permeability of less than about 1 CFM as measured by ASTM D737 @ 125 Pa and attaching the thin film to the lower side of the first fabric layer.

In a fourth embodiment, the invention provides a composite fabric made by the process containing the steps of forming a first fabric layer having an upper and lower side, where the first fabric layer contains a plurality of synthetic polymer fibers and forming a second fabric layer having an upper and lower side, where the second fabric layer contains a plurality of synthetic polymer fibers. The synthetic polymer fibers comprise at least 30% of biobased carbon content as measured by ASTM D26866-20 Method B. The method further contains the steps of forming a thin film having an average weight of less than about 30 GSM and has an air permeability of less than about 1 CFM as measured by ASTM D737 @ 125 Pa and attaching the thin film to the lower side of the first fabric layer and the upper surface of the second fabric layer.

### BRIEF DESCRIPTION OF THE DRAWINGS

FIG. 1 illustrates one embodiment of the composite fabric.

FIG. 2 illustrates an alternative embodiment of the composite fabric.

### DETAILED DESCRIPTION OF THE INVENTION

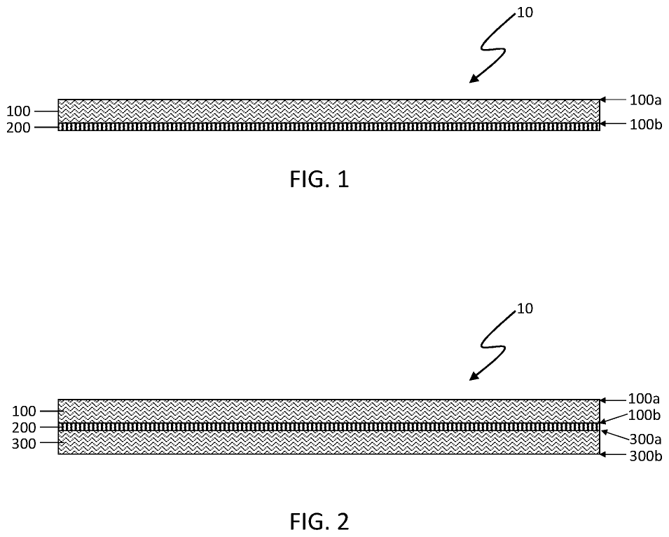

Referring now to FIG. 1, there is shown one embodiment of the composite fabric 10 of the invention having a first fabric layer 100 and a thin film 200. The first fabric layer 100 has an upper side 100a and a lower side 100b and the thin film 200 is attached to the lower side 100b of the first fabric layer 100.

FIG. 2 shows an alternate embodiment of the composite fabric 10 of the invention having a first fabric layer 100, a thin film 200, and a second fabric layer 300. The first fabric layer 100 has an upper side 100a and a lower side 100b and the thin film 200 is attached to the lower side 100b of the first fabric layer 100. The second fabric layer 300 has an upper side 300a and a lower side 300b and the thin film 200 is attached to the upper side 300b of the second fabric layer 300.

The first fabric layer 100 contains a plurality of synthetic polymer fibers and those synthetic polymer fibers contain at least about 15% bio-based carbon content as measured by ASTM D26866-20 Method B. Preferably, the second fabric layer 300 also contains a plurality of synthetic polymer fibers and those synthetic polymer fibers in the second fabric layer 300 contain at least about 15% bio-based carbon content as measured by ASTM D26866-20 Method B.

Recycling is normally referred to in the apparel industry is through mechanical recycling of polyester bottles, namely mechanical grinding of either pre or post-consumer PET bottles that is melted and extruded as yarn. Plant based materials on the other hand utilize plant-based building blocks of the polymer itself before a product, namely a yarn is made.

The first fabric layer 100 and/or the second fabric layer 300 can have any suitable construction including woven, knit, or nonwoven. In one embodiment, the fabric layers 100, 300 is a woven fabric. The layers 100, 300 may be the same (having the same construction and materials) or can be different.

In one embodiment, the first fabric layer 100 and/or the second fabric layer 300 are a woven fabric which may be, for example, plain, satin, twill, basket, poplin, jacquard, or crepe. Suitable plain weaves include, but are not limited to, rip stop weaves produced by incorporating, at regular intervals, extra yarns or reinforcement yarns in the warp, fill, or both the warp and fill of the fabric material during formation. Suitable twill weaves include both warp-faced and fill-faced twill weaves, such as 2/1, 3/1, 3/2, 4/1, 1/2, 1/3, or 1/4 twill weaves. In certain embodiments of the invention, such as when the fabric material is formed from two or more pluralities or different types of yarns, the yarns are disposed in a pattern-wise arrangement in which one of the yarns is predominantly disposed on one surface of the fabric material. In other words, one surface of the fabric material is predominantly formed by one yarn type. Suitable pattern-wise arrangements or constructions that provide such a fabric material include, but are not limited to, satin weaves, sateen weaves, and twill weaves in which, on a single surface of the fabric, the fill yarn floats, and the warp yarn floats are of different lengths.

In another embodiment, the first fabric layer 100 and/or the second fabric layer 300 is a knit fabric, for example a circular knit, reverse plaited circular knit, double knit, single jersey knit, two-end fleece knit, three-end fleece knit, terry knit, or double loop knit, weft inserted warp knit, warp knit, and warp knit with or without a micro-denier face.

In another embodiment, the first fabric layer 100 and/or the second fabric layer 300 is a multi-axial, such as a tri-axial fabric (knit, woven, or non-woven). In another embodiment, the first fabric layer 100 is a bias fabric. In another embodiment, the first fabric layer is a unidirectional fabric and may have overlapping yarns or may have gaps between the yarns.

In another embodiment, the first fabric layer 100 and/or the second fabric layer 300 is a non-woven fabric. The term “non-woven” refers to structures incorporating a mass of yarns or fibers that are entangled and/or heat fused to provide a coordinated structure with a degree of internal coherency. Non-woven fabrics may be formed from many processes such as for example, melt spun processes, hydroentangeling processes, mechanically entangled processes, stitch-bonding processes, and the like.

In some embodiments, the first fabric layer 100 and/or the second fabric layer 300 contains any yarns which may be any suitable yarn. “Yarn”, in this application, as used herein includes a monofilament elongated body, a multifilament elongated body, ribbon, strip, yarn, tape, fiber and the like. The first fabric layer 100 may contain one type of yarn or a plurality of any one or combination of the above. The yarns may be of any suitable form such as spun staple yarn, monofilament, or multifilament, single component, bi-component, or multi-component, and have any suitable cross-section shape such as circular, multi-lobal, square or rectangular (tape), and oval. The fabric layers 100, 300 can be formed from a single plurality or type of yarn or the fabric can be formed from several pluralities or different types of yarns

The first fabric layers 100 preferably contains a plurality of synthetic polymer fibers (which may or may not be formed into yarns) having at least about 15% bio-based carbon content as measured by ASTM D26866-20 Method B. In one embodiment, all synthetic polymer fibers (which may or may not be formed into yarns) together in the first fabric layer 100 have at least about 15% bio-based carbon content as measured by ASTM D26866-20 Method B.

The second fabric layer 300 contains a plurality of synthetic polymer fibers (which may or may not be formed into yarns) having at least about 15% bio-based carbon content as measured by ASTM D26866-20 Method B. In one embodiment, of all synthetic polymer fibers (which may or may not be formed into yarns) together have at least about 15% bio-based carbon content as measured by ASTM D26866-20 Method B.

ASTM D26866-20 Method B measures the percentage of bio-based carbon in a material. 100% biobased carbon would indicate that a material is entirely sourced from plants or animal by-products and 0% biobased carbon would indicate that a material did not contain any carbon from plants or animal by-products. A value in between 0 and 100% represents a mixture of natural and fossil sources. The higher the value, the greater the proportion of naturally sourced components in the material.

In one embodiment, the synthetic polymer fibers of the first fabric layer contain at least about 15% of bio-based carbon content as measured by ASTM D26866-20 Method B, more preferably at least about 20%, 30%, 35%, 40%, or 50%. In one embodiment, the synthetic polymer fibers of the first fabric layer contain between about 10 and 70%, more preferably between about 15 and 50%, more preferably between about 15 and 35% of bio-based carbon content. In another embodiment, the first fabric layer contains at least about 15% of bio-based carbon content as measured by ASTM D26866-20 Method B, more preferably at least about 20%, 30%, 35%, 40%, or 50%. In one embodiment, the first fabric layer contains between about 10 and 70%, more preferably between about 15 and 50%, more preferably between about 15 and 35% of bio-based carbon content.

In one embodiment, the synthetic polymer fibers of the second fabric layer contain at least about 15% of bio-based carbon content as measured by ASTM D26866-20 Method B, more preferably at least about 20%, 30%, 35%, 40%, or 50%. In one embodiment, the synthetic polymer fibers of the second fabric layer contain between about 10 and 70%, more preferably between about 15 and 50%, more preferably between about 15 and 35% of bio-based carbon content. In another embodiment, the second fabric layer contains at least about 15% of bio-based carbon content as measured by ASTM D26866-20 Method B, more preferably at least about 20%, 30%, 35%, 40%, or 50%. In one embodiment, the second fabric layer contains between about 10 and 70%, more preferably between about 15 and 50%, more preferably between about 15 and 35% of bio-based carbon content.

In one embodiment, the synthetic polymer fibers comprise a polyamide also referred to as nylon. Preferably, this polyamide is at least one of the fibers that contains bio-based carbon content. In one preferred embodiment, the nylon is nylon 5,6 and in another preferred embodiment, the nylon is nylon 11. Plant based building blocks for making nylon 5,6 and nylon 11 polymer were utilized in this invention. For example, Nylon 6,6 is prepared by step growth polymerization of hexamethylene diamine and adipic acid. In case of nylon 5,6, pentamethylenediamine comes from fermentation from plants, mainly corn. Hence, the biobased content on the nylon 5,6 in this invention is about 45%. In the case of nylon 11 for example is produced by the polymerization of 11-aminoundecanoic acid that comes from caster beans.

In another embodiment, the synthetic polymer fibers comprise a polyester. Preferably, this polyester is at least one of the fibers that contains bio-based carbon content. The two polyester feedstocks for making polyester resin are purified terephthalic acid (PTA) and mono ethylene glycol (MEG). In this invention, MEG comes from plant-based source instead of petroleum based. The Bio source can be from plant based, plant-based waste or off-gas from the industry.

Referring back to FIG. 1, the composite fabric 10 also contains a thin film 200 located on the lower side 100b of the first fabric layer 100. The thin film 200 contains at least 15% of biobased carbon content as measured by ASTM D26866-20 Method B, has an average weight of less than about 30 GSM, and has an air permeability of less than about 1 CFM as measured by ASTM D737 @ 125 Pa.

Preferably, the thin film 200 is a single layer, monolithic film. In another embodiment the thin film contains multiple layers such as by co-extrusion or coating. In another embodiment, the composite fabric contains more than one thin film, where the thin films may be adhered together optionally using an adhesive or may have another fabric layer between them.

The thin film 200 preferably contains a synthetic polymer, more preferably a polyamide or polyester. In one preferred embodiment, the thin film contains the same class of polymer as the first fabric layer. In another embodiment, the thin film 200 preferably consists essentially of a synthetic polymer, more preferably a polyamide or polyester. “Consists essentially” in this application is defined to mean at least about 90% by weight. In one embodiment, both the first polymer layer and the thin film contain polyamide. In one preferred embodiment, the polyamide (nylon) is nylon 5,6 and in another preferred embodiment, the nylon is nylon 11. In another embodiment, both the first polymer layer and the thin film contain polyester. Having the polymers in both the fabric layer(s) and the thin film match increases the probability that the composite fabric could be recycled.

In one embodiment, the thin film 200 contains at least about 15% of bio-based carbon content as measured by ASTM D26866-20 Method B, more preferably at least about 20%, 30%, 35%, 40%, or 50%. In one embodiment, the thin film 200 contains between about 10 and 70%, more preferably between about 15 and 50%, more preferably between about 15 and 35% of bio-based carbon content.

In one embodiment, the thin film has an average weight of less than about 25 GSM, more preferably less than about 20 GSM. When it comes to comfort of the wearer and depending on the end-use, lower weights of the membrane and fabric that it is laminated to are preferred against the performance. The combination of the membrane and the fabric structure proposed in this invention takes both comfort and performance into consideration.

In one embodiment, the composite fabric has a moisture vapor transmission rate (MVTR) of the composite fabric as measured by the test method JIS L1099-B1 is greater than about 20,000 g/m²/24 h, it has been found that this range provides a fabric that has good breathability go heading out to the hills for an extended trip. In another embodiment, the composite fabric has a moisture vapor transmission rate (MVTR) of the composite fabric as measured by the test method ASTM E96B for the water inverted version being greater than 2500 g/d*sq.m. In another embodiment, the composite fabric has a hydrostatic head as measured by the test method AATCC 127 is greater than about 15,000 (mm H₂O), more preferably greater than about 20,000 (mm H₂O), which has been shown to give good rainproof and waterproof characteristics.

In one embodiment, the entire composite fabric 10 (taken as a whole including all layers and adhesives) contains at least about 15% by weight of bio-based carbon content as measured by ASTM D26866-20 Method B, more preferably at least about 20%, 30%, 35%, 40%, or 50% by weight. In one embodiment, the entire composite fabric 10 contains between about 10 and 70%, more preferably between about 15 and 50%, more preferably between about 15 and 35% of bio-based carbon content.

In one embodiment, the composite fabric consists essentially of polyamide, which is defined in this application to mean at least 90% by weight polyamide. In another embodiment, the composite fabric consists essentially of polyester, which is defined in this application to mean at least 90% by weight polyester.

The composite fabric may contain a first adhesive layer between the first fabric layer 100 and the thin film and/or a second adhesive layer between the thin film 200 and the second fabric layer 300. These adhesive layers serve to adhere the composite together so that performance is sustained after multiple washing cycles. The adhesive layer(s) may be any suitable material, but in one preferred embodiment are of the same class of polymer as the first and second fabric layers 100/300 and thin film 200 so that the composite may be more easily recycled. In another embodiment, the adhesive layer may be based out of polyurethanes or polyacrylics.

Preferably, the adhesive layer is discontinuous to allow for between moisture transport through the composite. In one embodiment, the adhesive is applied using a gravure roller with a pattern, which may be in one example a discontinuous dot pattern. The adhesive may be applied to the fabric layers 100, 300 or the thin film 200.

In one embodiment, the composite is made by the process of forming a first fabric layer having an upper and lower side, where the first fabric layer contains a plurality of synthetic polymer fibers which are at least 20% of biobased carbon content as measured by ASTM D26866-20 Method B and also forming a thin film having an average weight of less than about 30 GSM and has an air permeability of less than about 1 CFM as measured by ASTM D737 @ 125 Pa. The thin film is attached to the lower side of the first fabric layer by an optional adhesive layer.

In another embodiment, the composite is made by the process of forming a first fabric layer having an upper and lower side, where the first fabric layer contains a plurality of synthetic polymer fibers which are at least 20% of biobased carbon content as measured by ASTM D26866-20 Method B and a second fabric layer having an upper and lower side, where the first fabric layer contains a plurality of synthetic polymer fibers which are at least 20% of biobased carbon content as measured by ASTM D26866-20 Method B. The method also contains the step of forming a thin film having an average weight of less than about 30 GSM and has an air permeability of less than about 1 CFM as measured by ASTM D737 @ 125 Pa. The thin film is attached to the lower side of the first fabric layer and the upper side of the second fabric layer by optional adhesive layers.

In another series of embodiments, the invention provides a garment comprising one or more pieces of composite fabric (both single and double fabric layer versions) of the invention. The one or more fabric pieces can be joined (e.g., sewn) together in such a way as to enclose an interior volume, which interior volume is intended to be occupied by a wearer or at least a portion of the anatomy of a wearer. Suitable examples of such garments include, but are not limited to, shirts, jackets, vests, pants, overalls, coveralls, hoods, and gloves. Alternatively, the garment need not be constructed so that it encloses an interior volume. Rather, the garment can be constructed so that a wearer can securely fasten it to his or her body so that it covers and protects at least a portion of his or her anatomy. Suitable examples of such garments include, but are not limited to aprons, bibs, chaps, and spats.

In one embodiment, the entire garment (taken as a whole) contains at least about 10% of bio-based carbon content as measured by ASTM D26866-20 Method B, more preferably at least about 15%, 20%, 30%, 35%, 40%, or 50%. In one embodiment, the entire garment contains between about 10 and 70%, more preferably between about 15 and 50%, more preferably between about 15 and 35% of bio-based carbon content.

In such embodiments of the invention, at least one of the fabric pieces of the garment comprises the composite fabric described above. Preferably, if the garment comprises multiple fabric pieces, all of the fabric pieces comprise the composite fabric described above. In a specific embodiment of a garment, the garment is a shirt comprising a plurality of fabric panels. At least one of the fabric panels defines a body covering portion of the shirt, and at least two of the fabric panels define sleeves attached to the body covering portion of the shirt. As noted above, at least one of the fabric panels of the shirt comprises the composite fabric described above. In another specific embodiment of such a garment, the garment is a pant comprising a plurality of fabric panels. At least two of the fabric panels define leg covering portions of the pant. As noted above, at least one of the fabric panels comprises the composite fabric described above.

The following examples further illustrate the subject matter described above but, of course, should not be construed as in any way limiting the scope thereof.

### EXAMPLE

A composite according to the invention was made with the following constructions. The first fabric layer was a woven fabric made using 40 denier nylon yarns having a plain weave construction with weight of 60 GSM. The second fabric is a knit fabric using 40 denier nylon yarns with the fabric weight in the range of 50 to 130 GSM.

The thin film consisted essentially of nylon 11 having a weight of 15 GSM.

The thin film was sandwiched between the first and second fabric layers with gravure printed adhesive layers between the fabric layers and the thin film. The adhesive layers were polyurethane and had a weight of about 15 GSM. The composite, taken as a whole, contained 36.28% of biobased carbon content as measured by ASTM D26866-20 Method B.

The film strength of the thin film was approximately 2.99 N in the warp direction and 5.95 N in the fill direction tested according to the tear strength test ISO 9073-4. In comparison, a traditional electrospun membrane could not even be tested according to this method (the membrane failed when tested with a 50 lb. load cell).

The composite was tested using the RET for breathability. RET is the measurement of the resistance to evaporative heat loss. The lower the Ret value, the less resistance to moisture transfer and therefore higher breathability. Also known as ISO-11092 or the RET or Hohenstein test. In this test, fabric is placed above a porous metal plate. The plate is heated, and water is channeled into the metal plate, simulating perspiration. The plate is then kept at a constant temperature. As water vapor passes through the plate and the fabric, it causes Evaporative Heat Loss and therefore more energy is needed to keep the plate at a constant temperature. RET is the measurement of the resistance to evaporative heat loss. The composite from this invention had a RET of 5.71 m²*Pa/W. An RET value of 0-6: the fabric is extremely breathable. It is comfortable at a higher activity rate. A commercially available composite had a RET of 6.34 m²*Pa/W.

The composite had an air permeability of less than 1.0 CFM as measured by ASTM D737 @ 125 Pa and a hydrostatic head of 20,000 mm H₂O as measured by the test method AATCC 127.

The composite of the example was shown to have be light weight, have low air permeability, high RET, and high amount of biobased carbon content making it ideal for many high-performance garments.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A composite fabric comprising:
a first fabric layer having an upper and lower side, wherein the first fabric layer comprises a plurality of synthetic polymer fibers, wherein the synthetic polymer fibers comprise at least about 15% of bio-based carbon content as measured by ASTM D26866-20 Method B;
a thin film located on the lower side of the first fabric layer, wherein the thin film comprises at least 15% of biobased carbon content as measured by ASTM D26866-20 Method B, wherein the thin film has an average weight of less than about 30 GSM and has an air permeability of less than about 1 CFM as measured by ASTM D737 @ 125 Pa.

2. The composite fabric of claim 1, wherein the thin film comprises polyester.

3. The composite fabric of claim 1, wherein the thin film comprises nylon 11.

4. The composite fabric of claim 1, wherein the synthetic polymer fibers comprise a material selected from the group consisting of polyamide and nylon 5,6.

5. The composite fabric of claim 1, wherein the moisture vapor transmission rate (MVTR) of the composite fabric as measured by the test method JIS L1099-B1 is greater than about 20,000 (g/m²/24 h).

6. The composite fabric of claim 1, wherein the moisture vapor transmission rate (MVTR) of the composite fabric as measured by the test method ASTM E96B for the water inverted version is greater than about 2500 g/d*sq.m.

7. The composite fabric of claim 1, wherein the hydrostatic head of the composite fabric as measured by the test method AATCC 127 is greater than about 15,000 (mm H2O).

8. The composite fabric of claim 1, wherein the synthetic polymer fibers comprise a polyester.

9. The composite of claim 1, wherein the composite comprises at least 30% of biobased carbon content as measured by ASTM D26866-20 Method B.

10. The composite of claim 1, further comprising a first adhesive layer located between the first textile layer and the thin film.

11. The composite of claim 1, wherein the composite fabric consists essentially of polyamide, wherein consists essentially is defined as being at least 90% by weight polyamide.

12. The composite of claim 1, wherein the thin film has an average weight of less than about 25 GSM.

13. The composite of claim 1, wherein the first fabric layer is selected from the group consisting of a woven, knit, and a nonwoven.

14. The composite of claim 1, wherein the composite further comprises a second fabric layer having an upper and lower side, wherein the second layer is located on the thin film on the side opposite to the first layer, wherein the second fabric layer comprises a plurality of synthetic polymer fibers, wherein the synthetic polymer fibers comprise at least 15% of biobased carbon content as measured by ASTM D26866-20 Method B.

15. A garment made using the composite fabric of claim 1.

16. A composite fabric made by the process comprising:
forming a first fabric layer having an upper and lower side, wherein the first fabric layer comprises a plurality of synthetic polymer fibers, wherein the synthetic polymer fibers comprise at least 20% of biobased carbon content as measured by ASTM D26866-20 Method B,
forming a thin film having an average weight of less than about 30 GSM and has an air permeability of less than about 1 CFM as measured by ASTM D737 @ 125 Pa; and
attaching the thin film to the lower side of the first fabric layer.

17. The composite fabric made by the process of claim 16, further comprising forming a second fabric layer having an upper and lower side, wherein the second fabric layer comprises a plurality of synthetic polymer fibers, wherein the synthetic polymer fibers comprise at least 30% of biobased carbon content as measured by ASTM D26866-20 Method B and attaching the thin film to the upper side of the second fabric layer.

18. The composite fabric made by the process of claim 16, wherein the synthetic polymer fibers comprise a material selected from the group consisting of polyamide, nylon 5,6, and polyester.

19. The composite fabric made by the process of claim 16, wherein the thin film comprises nylon 11.

20. The composite made by the process of claim 16, wherein the step of attaching the thin film to the lower side of the first fabric layer comprises applying a first adhesive layer to the first textile layer or the thin film.

21. The composite made by the process of claim 16, wherein the composite fabric consists essentially of polyamide, wherein consists essentially is defined as being at least 90% by weight polyamide.

22. The composite made by the process of claim 16, wherein the first fabric layer is selected from the group consisting of a woven, knit, and a nonwoven.
